(19) United States
(12) Patent Application Publication
(10) Pub. No.: US 2004/0098274 A1
(43) Pub. Date: May 20, 2004

(54) System and method for predicting customer contact outcomes

(76) Inventors: Anthony J. Dezonno, Bloomingdale, IL (US); Mark J. Power, Carol Stream, IL (US); Kenneth Venner, Las Flores, CA (US); Jared Bluestein, Wilmot, NH (US); Jim F. Martin, Woodside, CA (US); Darryl Hymel, Batavia, IL (US); Craig R. Shambaugh, Wheaton, IL (US); Laird C. Williams, Raleigh, NC (US)

Correspondence Address: Welsh & Katz, Ltd., Jon P. Christensen, 22nd Floor, 120 South Riverside Plaza, Chicago, IL, 60606, US

(21) Appl. No.: 10/295,275

(22) Filed: Nov. 15, 2002

(51) Int. Cl. G06F 17/60

(52) U.S. Cl. 705/1

(57) ABSTRACT

Systems and methods of predicting transaction outcomes based on monitoring customer and agent interactions in a customer contact center including monitoring a customer and agent interaction for current attributes and analyzing the current attributes and an attribute history to determine an outcome probability for the interaction. The outcome probability is indicated to the agent and the current attributes and the outcome probability are stored in the attribute history. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### FIELD OF THE INVENTION

This invention relates generally to communication systems and, more particularly, to customer contact centers.

### BACKGROUND

Communications systems with customer contact centers are known. Such systems are typically used as a means of distributing customer contacts, such as telephone calls, among a group of agents of an organization. As customer contacts are directed to the organization from a communications network, such as a public switched telephone network (PSTN), the communications system directs the customer contacts to its agents based upon some algorithm. For example, a communications system such as an automatic call distributor (ACD), a private branch exchange (PBX), or a central office exchange service (Centrex) may recognize a call target based upon an identity of an incoming trunk line and route the call accordingly.

Businesses, service organizations, and other entities may use customer contact centers to handle the daily influx of telephone calls, email messages and voice mail contacts for marketing, sales, product support, and other customer service functions. Agents of the communications systems may provide product support, take sales orders, and handle inquiries. In essence, the agents provide the wide array of services that the companies that use them require.

The effectiveness and efficiency of a communications system may depend on the performance of the agents. Successful agent and customer interactions may depend on an agent's well-informed advice and knowledge particular to the customer. Communication systems may provide the agents with ready access to customer files. Further, customer records may be displayed on agent terminals as the agent converses with specific customers. The communications system may transfer an identifier of the customer to a host computer based upon an automatic number identification (ANI) facility operating from within the PSTN. A host computer may then display the customer records on the agent's terminal at the time the call is delivered.

However, the present format may be limited. Currently, agents may only have historical call information. An agent may know, for example, that a particular customer called a week ago with a software installation concern or to order a particular product. Such information may or may not help an agent handling a subsequent call. Further, during a call interaction, an agent may not have time to thoroughly understand prior concerns of the customer and thus is limited in his or her ability to handle the call. Accordingly, a need exists for a system and method for predicting customer contact outcomes.

### SUMMARY

Under one embodiment of the invention, disclosed is a method of predicting transaction outcomes based on monitoring customer and agent interactions in a customer contact center including monitoring a customer and agent interaction for current attributes and analyzing the current attributes and an attribute history to determine an outcome probability for the interaction. The outcome probability is indicated to the agent and the current attributes and the outcome probability are stored in the attribute history.

Other embodiments, features and advantages of the invention will be apparent to one with skill in the art upon examination of the following figures and detailed description. It is intended that all such additional embodiment, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a communications system utilizing an embodiment of the present invention.

FIG. 2 illustrates a flow diagram of an embodiment of the present invention.

FIG. 3 illustrates an example Bayesian network utilized in the communications system of FIG. 1.

FIG. 4 illustrates an alternative embodiment of the present invention.

### DETAILED DESCRIPTION

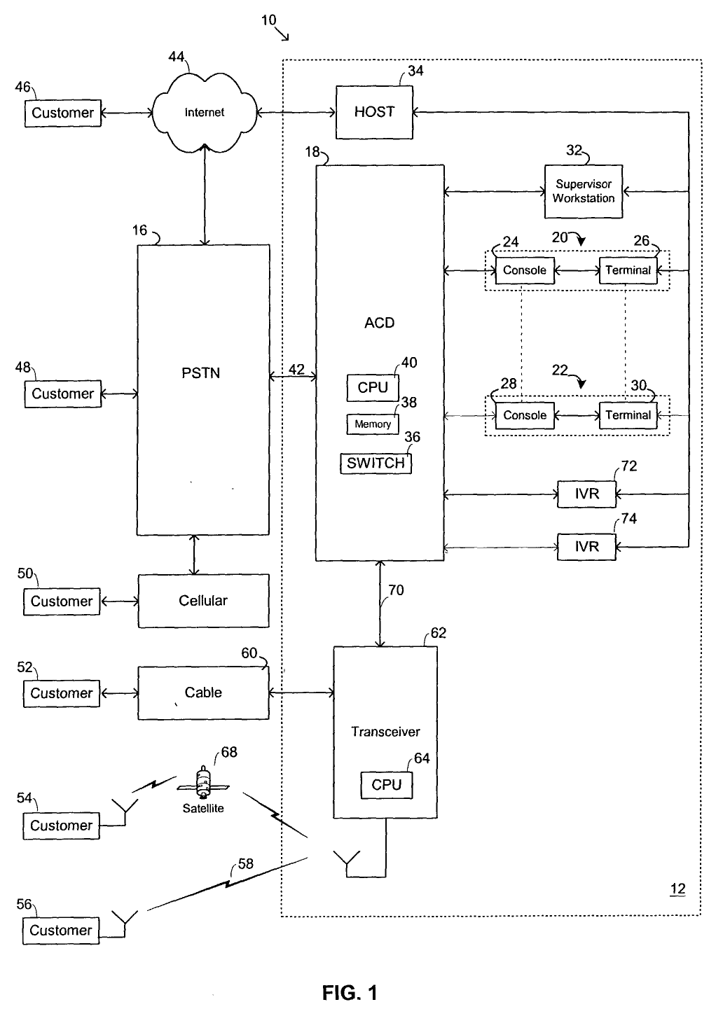

FIG. 1 depicts a block diagram of an exemplary embodiment of a transaction processing system 10 which may be used to route customer contacts across multiple access channels to a customer contact center 12. The customer contact center 12 may be defined as a communication technology that enables customers and agents of an enterprise to communicate across multiple access channels, including but not limited to telephone, Internet, radio, cellular, satellite, cable, facsimile, email, web and video. As shown in FIG. 1, the customer contact center 12 may be described with reference to an automatic call distributor (ACD) 18. As is known in the art, a PBX, Centrex system or other system capable of incoming and/or outgoing communications may also be used in place of the ACD 18. Implementing a customer contact center 12 with any suitable switching system is considered to be equivalent and variations will not be further discussed. In addition, the customer contact center 12 is also often identified by other terms including call center, connected call center, customer care center, customer communications center and services center.

As used herein, a customer contact may be based on any suitable communications connection including, but not limited to, a switched circuit connection (i.e., through the PSTN) or a packet data connection (e.g., through the Internet). A switched circuit connection (also sometimes referred to simply as a “telephone connection” in the telephony arts) refers to a dedicated channel existing between two parties. As used herein, a packet data connection does not necessarily represent a physical connection, but may simply be the possession and concurrent use by two users of the other user's identifier (e.g. IP address).

In the illustrated embodiment, customer contacts may be received from customers 46, 48, 50, 52, 54, 56 and may be routed by a matrix switch 36 of the ACD 18 to a selected transaction processing entity (e.g., agent stations 20, 22 or interactive voice response units (IVRs) 72, 74) of the transaction processing system 10. The customer may, for example, use a conventional telephone or cell phone and/or a computer to place/receive a contact with the transaction processing system 10. Alternatively, the customer 52 may place/receive a contact using an interactive channel of a community antenna television (CATV) system 60, land mobile radio 56 or a transmission channel of a satellite 68. Where the customer 52, 54, 56 places a customer contact using an interactive channel of a community antenna television (CATV) system 60, a land mobile radio 56 or a transmission channel of a satellite 68, often such a customer contact is initiated by the entry of a target identifier (e.g., a telephone number of the ACD 18). Customer contacts through the Internet 44 may occur as any Internet communications including email, chat sessions, file transfers, and teleconferences. Further, the customer contacts may include voice over IP (VoIP) communications.

As mentioned above, customer contacts may be processed by transaction processing entities, such as agent stations 20, 22 or IVRs 72, 74. Where the transaction processing entity is an agent station 20, 22, the agent station 20, 22 may include a telephone console 24, 28 and a terminal 26, 30. In addition, each terminal 26, 30 may include an input device, such as a keyboard or mouse. Additionally, the agent may wear a headset that provides audio communications between the agent and the customer 46, 48, 50, 52, 54, 56. The headset may be connected to the customer 46, 48, 50, 52, 54, 56 through the agent's telephone console 24, 28 and the ACD 18. The headset may also be connected to the customer 46, 48, 50, 52, 54, 56 through the agents terminal 26, 30, a host computer 34 and the Internet for conducting VOIP communications. The headset typically includes a microphone and one or more speakers. Accordingly, the voice of the customer 46, 48, 50, 52, 54, 56 is heard by the agent through the headset and may be recorded by a recording device in the agent station 20, 22 or by the host computer 34. Similarly, customer contacts may be processed by supervisor workstation 32 just as the customer contacts may be processed by the agent stations 20, 22.

While the transaction processing system 10 has been described with reference to customer contacts initiated by the customer 46, 48, 50, 52, 54, 56, it should be understood that customer contacts may just as well be initiated by the transaction processing system 10. For example, customer lists may be maintained in a database of the host 34. The CPU 40 of the system 10 may initiate customer contacts to the customers 46, 48, 50, 52, 54, 56 by accessing the database of the host 34. The database of the host 34 may maintain customer records, including a customer identifier, demographic data, and routing information.

Customer contacts initiated by the transaction processing system 10 may be placed through the PSTN 16, radio frequency (RF) transceiver 62 or by the host 34 through the Internet 44. In one embodiment, associated with each customer 46, 48, 50, 52, 54, 56 may be a customer identifier and routing information. The identifier may be an identifier used for identifying the customer 46, 48, 50, 52, 54, 56 within a particular communication system (e.g., a telephone number within the PSTN 16, an IP address within the Internet 44, a customer account number within the CATV system 60, an electronic serial number (ESN) within the land mobile radio 56 or satellite system 56, etc.). In addition, the routing information may be used to identify the particular system (e.g., PSTN 16, Internet 44, CATV 60, land mobile radio 56, satellite 68, etc.) within which the identifier is to be used. In one embodiment, the routing information may identify the port through which the customer contact is to be processed. For example, a port for an Internet customer contact may be an Internet connection with the host 34. A telephone customer contact may be processed through a first set of trunk connections 42 using a respective port of the matrix switch 36 of the ACD 18. A customer contact with a cable subscriber 52, land mobile user 56 or satellite customer 54 may be processed through a second set of trunk connections 70 using a respective port of the matrix switch 36 of the ACD 18. The identifier and routing information may, together, be referred to herein as customer contact associated information. By using the customer contact associated information, the system 10 may initiate outgoing customer contacts to the customers 46, 48, 50, 52, 54, 56. The bi-directional nature of transaction processing of customer contacts in some embodiments may be reflected by using the phrase “customer contacts with customers 46, 48, 50, 52, 54, 56”. Further, the various embodiments and implements thereof to form communication between a customer 46, 48, 50, 52, 54, 56 and an agent station 20, 22 of a customer contact center 12 are known in the communications art and will not be further described herein. For example, the functionality performed by the ACD 18 and the host 34 may be combined as is known to a person of ordinary skill in the art.

Whether a customer contact is incoming or outgoing, the distribution of the customer contact to transaction processing entities 20, 22, 72, 74 may be substantially the same. When the customer contact is outgoing, the transaction processing system 10 inherently knows the type of the customer contact and the identity of the customer target. When the customer contact is incoming, the transaction processing system 10 may determine the type of the customer contact and the identity of the customer contact based upon the customer contact associated information (e.g., a port number and ANI or IP address information in the case of the Internet). By knowing the type of the customer contact, the transaction processing system 10 may route the customer contact based upon an understanding of capabilities of the transaction processing entities 20, 22, 72, 74 or some other well-known criteria. For example, knowing that the customer contact is an email communication, the transaction processing system 10 may route the customer contact to a transaction processing entity such as an email server.

Customer contact delivery to a transaction processing entity 20, 22, 72, 74 may be accomplished under several formats. For example, where the customer contact is of a switched circuit format, the CPU 40 selects a transaction processing entity 20, 22, 72, 74 and delivers the customer contact to the console 24, 26 of the selected agent station 20, 22 or to the selected IVR 72, 74. The CPU 40 may send a customer contact delivery message including customer contact associated information (e.g. DNIS, ANI, ESN, switch port number, etc.) to the host 34. Customer contact associated information may be used by the CPU 40 as a means of routing the customer contact. Where the host 34 is able to identify customer records, the host 34 may present those records to the selected customer contact processing entity 20, 22, 72, 74 at the instant of delivery (e.g., as a screen pop on a terminal 26, 30 of the selected agent station).

Incoming customer contacts through the Internet may also be routed by the host 34 based upon customer contact associated information (e.g., the IP address of the customer 46). If the customer is an existing customer, the host 34 may identify the customer in its database using the IP address of the customer contact as a search term. As above, customer records of the customer may be used as a basis for routing the customer contact. If the customer contact 46 is not an existing customer, then the host 34 may route the customer contact based upon the context (e.g., an identity of a website visited, a webpage from which a query originates, and contents of a shopping basket). Further, an attribute history may be created for the customer contact, where the attribute history captures attributes about the present customer contact interaction. Attributes include information relevant to making a prediction about the success of the current interaction and include, for example:

(1) demographic information about the customer 46, 48, 50, 52, 54, 56, e.g. age and sex of the customer;

(2) previous customer contact history, e.g. dates and summaries of previous conversations;

(3) agent's demeanor and personal characteristics, e.g. age and sex of the agent;

(4) call attributes, e.g. voice pitch, intensity, and duration;

(5) previously used speech characteristics, e.g. use of colloquial English words like “honey,” “sugar” and “baby”; and

(6) other features or characteristics associated with the interaction.

If the customer 46, 48, 50, 52, 54, 56 is a known customer then a previously stored attribute history may be loaded from the database into the host computer 34. The attribute history may include information about the attributes described above. Further, as the interaction continues, the attribute history may be added to with information regarding the current customer contact interaction.

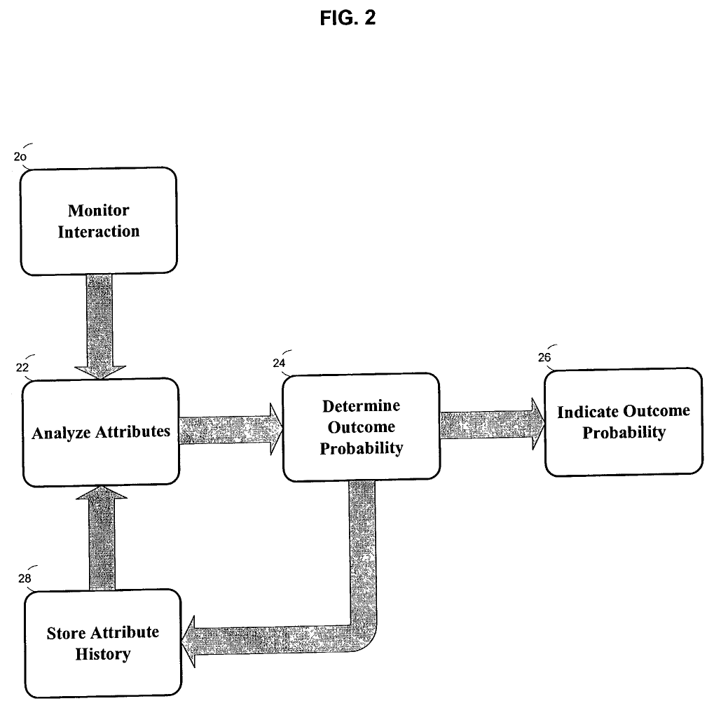

As illustrated in FIG. 2, in operation, an embodiment of the present invention predicts transaction outcomes in a customer contact center 12 by (a) monitoring a customer contact interaction between a customer and an agent for current attributes (see Block 20), (b) analyzing the current attributes and an attribute history to determine an outcome probability for the interaction (see Blocks 22, 24), (c) indicating the outcome probability to the agent (see Block 26) and (d) storing the current attributes and the outcome probability in the attribute history (see Block 28). An interaction may be defined as a conversation between an agent and a customer 46, 48, 50, 52, 54, 56 starting when the customer contact is received by the agent and ending when the customer contact is disconnected.

The step of monitoring (see Block 20) functions to assess and retrieve attributes related to the current interaction. The step of analyzing (see Blocks 22, 24) functions to provide a prediction of how well the interaction is going. The step of indicating (see Block 20) functions to alert the agent involved in the interaction of how well he is doing in the current interaction, and if necessary to alert the agent to remedy attributes found to be not optimal. The step of storing (see Block 28) functions to provide information necessary for determining a future outcome probability for a future interaction.

In an illustrated embodiment of the present invention, the step of monitoring a customer and agent interaction for current attributes (see Block 20) may comprise selecting an audio channel associated with the interaction, extracting audio features from the selected audio channel and retrieving customer contact associated information. The step of monitoring (see Block 20) begins when an interaction begins and continues until the interaction is completed. For example, the interaction may begin when a customer contact is delivered to the agent telephone (3, 6, or 11) or to the agent terminal (2, 5, or 12). In an illustrative embodiment, the customer contact is a telephone call that is delivered to the agent telephone (3, 6, or 11).

The telephone call may be carried on an audio channel of ACD 18 where audio features of the interaction may be extracted. For example, audio features such as pitch and intensity may be extracted by measuring energy levels generated by the microphone of either the customer or the agent. Further, the audio channel may be used to extract speech associated with either the customer or agent. For example, audio features such as speech may be extracted by processing language of either the customer or the agent. Further, as an interaction begins customer contact associated information may be retrieved. For example, where an ANI, DNS or other customer information is delivered along with the call, such information is retrieved. Similarly, where the customer contact arrives as voice over IP, information such as the IP address of the customer or a list of items that are already in a shopping basket of the customer may be retrieved. As used herein, customer contact associated information may include ANI, DNIS, call duration, call disconnect, email address, credit card information, items in a shopping basket, caller entered digits, holding time, average speed of answer, handling time, inter and local exchange carriers of the call, response time, and wrap-up codes.

The step of analyzing the current attributes and an attribute history to determine an outcome probability for the interaction (see Blocks 22, 24) functions to process available information about the interaction. This step requires analyzing voice characteristics, speech, and customer contact associated information and retrieving an attribute history to make an assessment regarding the success of the interaction.

Analyzing voice characteristics (see Block 22) includes processing the retrieved audio to detect whether an argument or dispute is occurring in the interaction. For example, changes in pitch during a conversation may indicate a developing dispute. Further, voice characteristics may be compared to the attribute history to determine whether the current voice characteristics are abnormal for the customer 46, 48, 50, 52, 54, 56. Analyzing voice characteristics may detect when frequent interruptions occur. Detecting frequent interruptions is done by comparing PCM samples from a forward voice channel (i.e. voice from the customer to the agent) with PCM samples from a reverse voice channel (i.e. voice form the agent to the customer). By comparing the temporal proximity of the PCM samples above a certain threshold level on the two channels, detection of interruptions can occur.

Analyzing speech characteristics (see Block 22) includes translating the retrieved audio into speech. The speech is then searched for indications of the use of profanity, inappropriate language or use of the word “supervisor.” Inappropriate language comprises stored parameters that comprise words such as “hate,” “kill,” and “honey.” Further, if profanity or inappropriate language is found in the speech, then the attributy history is searched to determine whether the speech is normal for the customer 46, 48, 50, 52, 54, 56. For example, a customer from a Southwestern state may address the agent using the word “sugar” which typically may be considered inappropriate language, but after comparing the language to the attribute history may be considered to be normal for the customer 46, 48, 50, 52, 54, 56. Further, the speech is searched for indications of the customer's request to speak to the supervisor. Such requests may comprise using words or phrases such as “supervisor,” “boss,” “manager,” and “person in charge.” If the speech includes any of these stored words, then it is an indication that the customer is asking to speak to the supervisor.

Analyzing customer contact associated information (see Block 22) includes comparing delivered customer contact associated information with the attribute history to determine whether the customer 46, 48, 50, 52, 54, 56 is problematic. For example, where ANI information is delivered along with the call, the ANI information may be used to compare the ANI information with a list of problematic callers or the ANI information may be used to retrieve an attribute history which notes that the caller is problematic. Problematic may mean a call interaction that is difficult or complex, a customer who is difficult to deal with, or a situation that is perplexing. As an example, in a retail sales organization, a problematic call may be one in which the agent has difficulty in concluding a sale or one in which an argument takes place between the agent and customer. In an emergency response center, a problematic call may be one in which the agent does not properly provide emergency information to the caller or one in which the agent and caller exchange obscene words.

Analyzing customer contact associated information (see Block 22) also means to look for unusual sequences of events. For example, if a customer contact disconnect occurs (i.e. initiated by the agent) after the customer contact has been of a long duration or if during a sales presentation, the agent enters an order form application but does not conclude a sale.

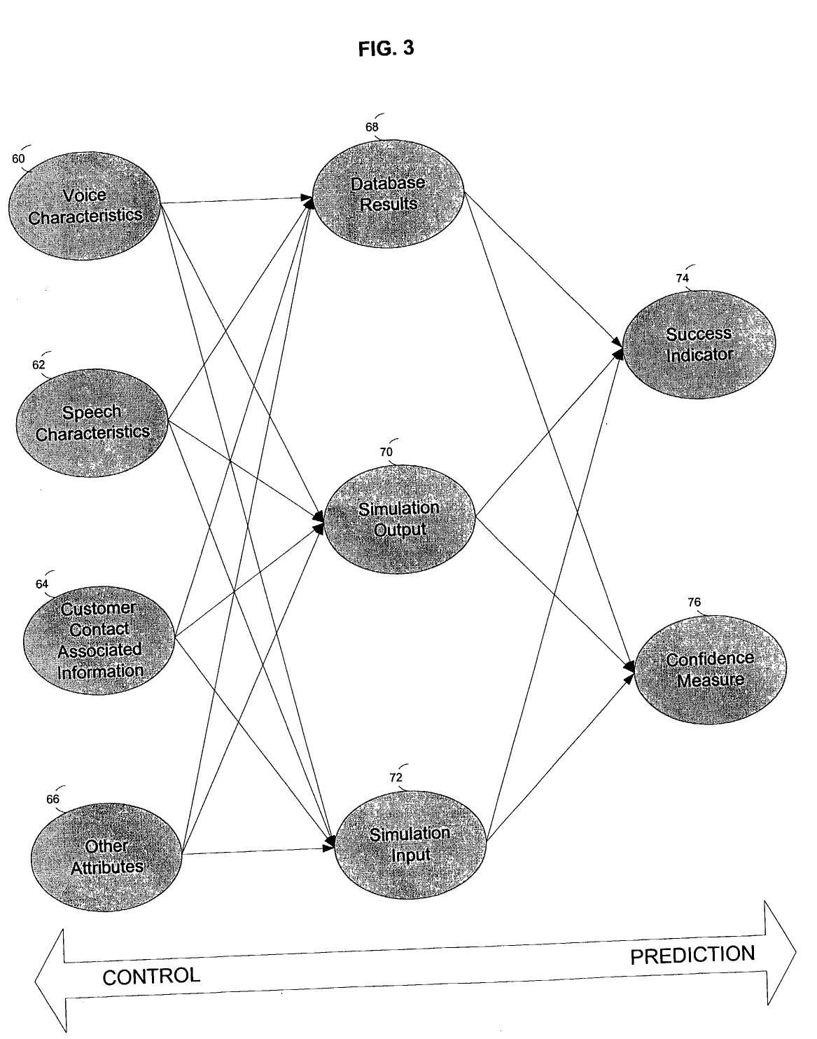

The step of analyzing the current attributes and an attribute history to determine an outcome probability (see Blocks 22, 24) further includes organizing the attributes by mapping out causal relationships among the attributes, encoding the attributes with numbers that represent the extent to which one attribute is likely to affect another attribute and calculating an outcome probability based on a probabilistic model of the causal relationships. In an exemplary embodiment, Bayesian network technology is utilized to perform the step of analyzing (see Blocks 22, 24) wherein as used herein Bayesian network technology means to take into account conditional probabilities and apply Bayes theorem to provide a rule for qualifying confidence (beliefs or probability) based on evidence. Shown in FIG. 3 is a Bayesian network for predicting the probability that a call interaction will be successful given the historical data and current call characteristics. Bayes theorem, known as the inversion formula, is listed below.

$$P ( H \vert e ) = \frac{P ( e \vert H ) P ( H )}{P ( e )}$$

The above equation states that the probability of (or belief in) hypothesis H upon obtaining evidence e is equal to the probability (or degree of confidence) that e would be observed if H is true, multiplied by the probability of H prior to learning evidence e (the previous belief that H is true), divided by the probability of evidence e. P(H|e) is referred to as the posterior probability. P(H) is referred to as the prior probability. P(e|H) is referred to as the likelihood; and P(e) is a normalizing constant. Bayesian analysis is particularly useful in an expert system because the likelihood can often be determined form experimental knowledge and the likelihood can be used to determine an otherwise difficult to determine posterior probability.

As mentioned above, the inversion formula can be used to quantify confidence based on multiple pieces of evidence. For example, with N pieces of evidence, the inversion formula would take the form shown as follows:

$$P ( H \vert {e}_{1} , {e}_{2} , … , {e}_{N} ) = \frac{P ( {e}_{1} , {e}_{2} , … , {e}_{N} \vert H ) P ( H )}{P ( {e}_{1} , {e}_{2} , … , {e}_{N} )}$$

It will be appreciated that a full joint distribution of probabilities based on N pieces of evidence will have 2^{N} values. If, however, it is known that each piece of evidence is independent of the others, the inversion formula can be reduced and the distribution can be reduced in size to N number of values.

$$P ( H \vert {e}_{1} , {e}_{2} , … , {e}_{N} ) = \frac{P ( H ) {\prod }_{i}^{} P ( {e}_{i} \vert H )}{{\prod }_{i}^{} P ( {e}_{i} )}$$

The example Bayesian network shown in FIG. 3 is a representational and computational model for reducing the computational complexity of a discrete disjoint probability distribution as described above. Each node in the model represents a random variable and each link represents probabilistic dependence among the linked variables. To reduce the difficulty of modeling, knowledge of casual relationships among variables is used to determine the position and direction of the links. The example Bayesian network shown in FIG. 3 has nine nodes labeled “Voice Characteristics,” “Speech Characteristics,” “Customer Contact Associated Information,” “Other Attributes,” “Database Results,” “Simulation Output,” “Simulation Input,” “Success Indicator,” and “Confidence Measure.” Each node is connected to at least one other node by a link which is designated as an arrow, the direction of which indicates probabilistic dependence. Thus, node “Database Results” is dependent upon nodes “Speech Characteristics,” “Customer Contact Associated Characteristics,” and “Other Attributes.” Node “Success Indicator” is dependent upon nodes “Database Results” and “Simulation Output.” Siblings in the model represents conditional independence. For example, nodes “Database Results” and “Simulation Output” are independent give the value of “Speech Characteristics.” Nodes at the tail end of a link are referred to as parents and parents which are not influenced by any other nodes are called root nodes. Each node in the graph represents a variable in the probability distribution. For each root node, the associated variable's marginal distribution is stored. For each non-root node, a probability matrix is created which indicates the conditional probability distribution of that node given the values of its parent nodes.

For example, as shown in FIG. 3, the value of the variable at node “Success Indicator” is related probabilistically to the value of the variables at nodes “Database Results” and “Simulation Output.” Shown in the table below is a probability matrix indicating the strength of the influences of nodes “Database Results” and “Simulation Output” on node “Success Indicator.”

| Success | (Database Results) | (Database Results) | (Database Results) | (Database Results) |
|---|---|---|---|---|
| Indicator | (Simulation Output) | (Simulation Output) | (Simulation Output) | (Simulation Output) |
| T | 0 89 | 0 85 | 0 89 | 0 30 |
| F | 0 11 | 0 15 | 0 11 | 0 70 |

The variable at node “Success Indicator” takes the value T with a probability of 0.89 when the variables at nodes “Database Results” and “Simulation Output” are T. When the variable at node “Database Results” is T but the variable at node “Simulation Output” is F (shown in the table above as \overline{Simulation Output}), the probability that the value of the variable at node “Success Indicator” drops to 0.85. When both the variables at nodes “Database Results” and “Simulation Output” are F (shown in the table above as \overline{Database Results} and \overline{Simulation Output}), the probability that the value at node “Success Indicator” is T drops to 0.30. For any given state of the parent nodes, the probabilities of the influenced node sum to one.

Practically, this may be understood to mean that when the historical data and the output of the simulator is good, the likelihood that the customer contact will be successful is also high and is suggested by the success indicator having a probability of 0.89. Conversely, when the historical data and the output of the simulator is low, the likelihood that the customer contact will be successful is also low and is suggested by the success indicator having a probability of 0.30.

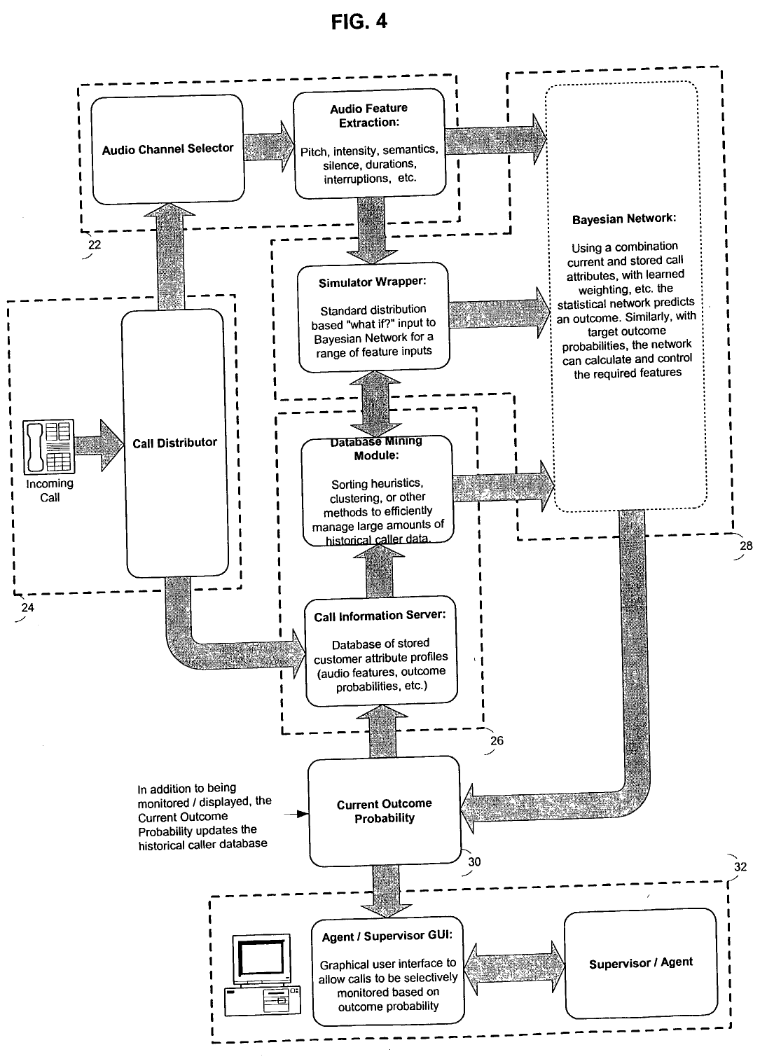

As shown in FIG. 4, the method may employ learning as a method of increasing the robustness of the Bayesian model. In an alternative embodiment, the method may employ learning as a method of increasing the detection of problematic customer contact interactions. The method recognizes and learns speech pattern regularities that appear over time. For example, a known customer may regularly use inappropriate language such as the use of the word “honey” to address the customer contact center agent. The method may recognize this type of speech and learn that usage of speech of this type by this customer may not be problematic. The ability to predict speech may allow the problematic customer contact system to be more efficient and increase the chances of accurately predicting problematic customer contact interactions.

In an alternative embodiment, the step of indicating (see Block 26) also functions to notify a supervisor of the customer interaction. Problematic may mean an interaction which is difficult or complex, a customer who is difficult to deal with, or a situation which is perplexing. As an example, in a retail sales organization, a problematic interaction may be one in which the agent has difficulty in concluding a sale or one in which an argument takes place between the agent and customer. In an emergency response center, a problematic interaction may be one in which the agent does not properly provide emergency information to the customer contact or one in which the agent and customer contact exchange obscene words.

The step of storing (see Block 28) functions to provide information for use in analyzing a later customer interaction. Customer interactions may be copied to the database 8 for use at a future date. Further, a means for playing back the customer interaction may be provided. An embodiment of the invention allows the supervisor the ability to listen to stored customer interactions. The supervisor may be able to select interactions where the voice intensity exceeds a specified threshold or choose interactions involving a specific customer. Alternatively, the supervisor may recognize and specify a normal pitch and word rate for an agent and select any interaction where the pitch or word rate exceeds a threshold. Further, the same criteria may be established for the other party to a conversation. Under an illustrated embodiment, interactions determined to be not optimal may be recorded and may be later retrieved. The host 34 may record interactions and send data about those interactions determined to be problematic to the database. Then, the database stores recorded interactions. The supervisor may want to retrieve the recorded interactions at a later date to analyze the weaknesses of the agent or the approach used by the agent to determine whether further training may be necessary.

While various embodiments of the invention have been described, it will be apparent to those of ordinary skill in the art that many more embodiments and implementations are possible that are within the scope of this invention.

What is claimed is:

1. A method of predicting transaction outcomes based on monitoring customer and agent interactions in a customer contact center comprising the steps of:
monitoring a customer and agent interaction for current attributes;
analyzing the current attributes and an attribute history to determine an outcome probability for the interaction;
indicating the outcome probability to an agent associated with the interaction; and
storing the current attributes and the outcome probability in the attribute history.

2. The method of predicting transaction outcomes as in claim 1 wherein attributes include audio features, customer contact routing information, customer contact identification, and customer contact duration.

3. The method of predicting transaction outcomes as in claim 1 wherein the step of monitoring further comprises the step of extracting audio features from a communication system carrying the customer and agent interaction.

4. The method of predicting transaction outcomes as in claim 3 wherein the communication system comprises an automatic call distributor and a public switch telephone network.

5. The method of predicting transaction outcomes as in claim 3 wherein audio features comprise pitch, frequency, intensity, semantics, word rate, interruption rate, and silence duration.

6. The method of predicting transaction outcomes as in claim 1 wherein the step of monitoring customer contacts for attributes further comprises the step of loading a stored customer attribute profile.

7. The method of predicting transaction outcomes as in claim 6 wherein stored customer attribute profiles comprise stored customer contact success probabilities and stored customer contact attributes for existing customers.

8. The method of predicting transaction outcomes as in claim 7 wherein stored customer attribute profiles comprise a set of target customer contact success probabilities and target customer contact attributes for new customers.

9. The method of predicting transaction outcomes as in claim 1 wherein the step of analyzing the current customer contact attributes further comprises the step of using predictive statistics and data simulation to calculate an outcome probability.

10. The method of predicting transaction outcomes as in claim 9 wherein predictive statistics comprise a Bayesian network for operating on both the current customer contact attributes and the stored customer attribute profile.

11. The method of predicting transaction outcomes as in claim 9 wherein the data simulation comprises distribution modeling to simulate an outcome probability for a range of current audio features and stored audio features.

12. The method of predicting transaction outcomes as in claim 1 wherein the step of analyzing the current customer contact attributes further comprises the step of using predictive statistics and data simulation to calculate the audio features required by a target outcome probability.

13. The method of predicting transaction outcomes as in claim 12 wherein predictive statistics comprises a Bayesian network of current outcome probability and stored outcome probabilities.

14. The method of predicting transaction outcomes as in claim 12 wherein the data simulation comprises distribution modeling to simulate calculating at least one required audio feature for a range of current outcome probabilities and stored outcome probabilities.

15. The method of predicting transaction outcomes as in claim 1 wherein indicating the outcome probability further comprises displaying the outcome probability on a graphical user interface.

16. The method of predicting transaction outcomes as in claim 1 wherein indicating the outcome probability further comprises displaying the audio features required to modify the current outcome probability on a graphical user interface.

17. The method of predicting transaction outcomes as in claim 16 wherein the step of displaying the audio features required to modify the current outcome probability on a graphical user interface further comprises advising the agent as to modifying at least one required audio feature to obtain a target outcome probability.

18. The method of predicting transaction outcomes as in claim 1 wherein storing the current customer contact attributes further comprises adding the current customer contact attributes to the database of stored customer attributes.

19. The method of predicting transaction outcomes as in claim 1 wherein the step of storing the current attributes further comprises the steps of:
recording the customer and agent interaction to create a customer contact profile;
referencing the customer and agent interaction using at least one of ANI, DNIS, name, time, and customer contact length; and
retrieving the customer contact profile to analyze the customer and agent interaction.

20. A system of predicting transaction outcomes based on monitoring customer and agent interactions in a customer contact center comprising the steps of:
a customer and agent interaction monitor that retrieves current attributes of a customer and agent interaction; and
a processor that computes an outcome probability for the customer and agent interaction based upon an analysis of the current attributes and an attribute history;
whereby the outcome probability is indicated to an agent associated with the interaction.

21. The system of predicting transaction outcomes as in claim 20 wherein attributes include audio features, customer contact routing information, customer contact identification, and customer contact duration.

22. The system of predicting transaction outcomes as in claim 20 wherein the customer and agent interaction monitor extracts audio features from a communication system carrying the customer and agent interaction.

23. The system of predicting transaction outcomes as in claim 22 wherein the communication system comprises an automatic call distributor and a public switch telephone network.

24. The system of predicting transaction outcomes as in claim 22 wherein audio features comprise pitch, frequency, intensity, semantics, word rate, interruption rate, and silence duration.

25. The system of predicting transaction outcomes as in claim 20 wherein the customer and agent interaction monitor further comprises an interface to a database of customer attributes.

26. The system of predicting transaction outcomes as in claim 25 wherein the database of customer attributes further comprises stored customer contact success probabilities.

27. The system of predicting transaction outcomes as in claim 26 wherein the database of customer attributes further comprises a set of target customer contact success probabilities and target customer contact attributes for new customers.

28. The system of predicting transaction outcomes as in claim 20 wherein the processor further comprises capability to perform predictive statistics and data simulation to calculate an outcome probability.

29. The system of predicting transaction outcomes as in claim 28 wherein predictive statistics comprises a Bayesian network for operating on both the current attributes and a stored customer attribute profile.

30. The system of predicting transaction outcomes as in claim 28 wherein the data simulation comprises distribution modeling to simulate an outcome probability for a range of current audio features and stored audio features.

31. The system of predicting transaction outcomes as in claim 20 wherein the processor further comprises the capability to perform predictive statistics and data simulation to calculate audio features required by a target outcome probability.

32. The system of predicting transaction outcomes as in claim 31 wherein predictive statistics comprises a Bayesian network of current outcome probability and stored outcome probabilities.

33. The system of predicting transaction outcomes as in claim 31 wherein the data simulation comprises distribution modeling to simulate calculating at least one required audio feature for a range of current outcome probabilities and stored outcome probabilities.

34. The system of predicting transaction outcomes as in claim 20 further comprising a graphical user interface that displays the outcome probability to the agent associated with the interaction.

35. The system of predicting transaction outcomes as in claim 34 further comprising a graphical user interface that displays audio features required to modify the current outcome probability.

36. The system of predicting transaction outcomes as in claim 35 further comprising an advisor that indicates which audio feature to modify to obtain a target outcome probability.

37. The system of predicting transaction outcomes as in claim 20 further comprising a database for storing the current attributes.

38. The system of predicting transaction outcomes as in claim 20 further comprising a database record for the customer and agent interaction referenced by using at least one of ANI, DNIS, name, time, and customer contact length.

39. A system for predicting transaction outcomes based on monitoring customer and agent interactions in a customer contact center comprising the steps of:
means for monitoring a customer and agent interaction for current attributes;
means for analyzing the current attributes and an attribute history to determine an outcome probability for the interaction;
means for indicating the outcome probability to an agent associated with the interaction; and
means for storing the current attributes and the outcome probability in the attribute history.
